(19) United States
(12) Patent Application Publication
(10) Pub. No.: US 2017/0191005 A1
(43) Pub. Date: Jul. 6, 2017

(54) AQUEOUS LIQUID DETERGENT FORMULATION COMPRISING ENZYME PARTICLES

(71) Applicant: CONOPCO, INC., D/B/A UNILEVER, Englewood Cliffs, NJ (US)

(72) Inventors: Morten FOVERSKOV, Herlev (DK); David Stephen GRAINGER, Bebington, Wirral Merseyside (GB); Henrik LUND, Soeborg (DK); John Francis WELLS, Bebington, Wirral Merseyside (GB)

(21) Appl. No.: 15/311,841

(22) PCT Filed: May 18, 2015
(86) PCT No.: PCT/EP2015/060857

§ 371 Date: Nov. 16, 2016

(30) Foreign Application Priority Data
May 22, 2014 (EP) 14169497.6

(51) Int. Cl. C11D 3/386; C11D 3/382; C11D 3/00; C11D 3/37; C11D 11/00

(52) U.S. Cl. CPC C11D 3/38627; C11D 3/38618; C11D 3/3753; C11D 11/0017; C11D 3/3715; C11D 3/0036; C11D 3/38672; C11D 3/382

(57) ABSTRACT

The present invention relates to an aqueous liquid laundry formulation comprising an ester based laundry ingredient; an effective cleaning amount of protease enzyme; an effective cleaning amount of lipase enzyme; and from 5 to 60 wt % surfactant; wherein at least 70 wt % of the effective cleaning amount of lipase enzyme is encapsulated and separated from the ester based laundry ingredient and the liquid by a coating which is insoluble in the formulation but which dissolves on dilution with the wash; and wherein the laundry formulation comprises at least 20 wt % water.

### TECHNICAL FIELD

The present invention relates to liquid laundry detergent formulations comprising at least one ester based laundry ingredient susceptible to degradation on exposure to lipase enzymes, at least one protease enzyme capable of providing protease activity when the formulation is diluted, and at least one lipase enzyme capable of providing lipase activity when the composition is diluted wherein the one or more lipase enzymes are separated from the protease enzyme.

### BACKGROUND

In the field of liquid laundry detergent formulations there exists a constant need to deliver improved cleaning technologies, especially as consumers move towards more ecologically friendly processes such as for example, reduced water utilization for each wash cycle.

One of the most desirable ingredients to include into a liquid detergent formulation is an enzyme system based on lipase enzymes for digesting fatty deposits. However, the successful incorporation of lipase into a liquid detergent formulation is very difficult to achieve due to the fact that most liquid detergent formulations also contain protease enzymes.

Protease enzymes readily digest lipases, even more so than other commonly used laundry enzymes such as amylases, leading to the production of modified lipase enzymes (WO 91/00910). The storage of liquid detergent formulations, comprising both proteases and lipases, even for short periods, generally results in loss of the cleaning benefits arising from the presence of lipase to the consumer; even before the liquid detergent enters a wash cycle. This is also the case, even when the protease enzymes are inhibited. For example, GB1107824 discloses a solid composition which possesses a mixture of lipase and protease and which dissolves on dissolution in water. Interestingly in this case, the importance of protecting protease activity from lipase attack is stressed.

In contrast, U.S. Pat. No. 5,281,356 (Unilever), WO 97/2177 (Unilever) and WO 99/01532 (Allied Colloids) all disclose the importance of protecting lipase enzyme activity in detergent formulations by encapsulating protease enzymes also present in detergent formulations. In addition, WO2008/084093 (Novozymes) describes liquid compositions in which a branched copolymer matrix of vinyl pyrrolidone and vinyl acetate is used to encapsulate lipase enzymes to protect same from proteolytic attack. In these documents a spray drying process is used for encapsulation leading to excessive leakage of enzymes into the formulation prior to use.

Alternatively, lipase activity in detergent formulations has been protected by encapsulation of lipase enzymes. For example, WO2008/137846 (Akermin), teaches the coating of lipase enzymes with a hydrophobically modified polysaccharide in a detergent formulation.

Another common material used to prepare capsules and which is suitable for protection of lipase enzymes in detergent formulations is polyvinylalcohol, as described in WO2012/004134 (Unilever), WO2011/127030 (Unilever), WO2010/062745, JP 2006/298971, JP 63/05098, and WO 90/00593. However, these documents are largely concerned with the protection of other detergent components, often with lipase and protease in the same capsule.

In addition, WO2006/132729 (Celanese International) discloses a modified polyvinyl alcohol copolymer that is said to be useful for coating enzymes. The exemplified copolymer is 97% hydrolysed and comprises, in addition to the usual polyvinyl alcohol and polyvinyl acetate, a minor amount (4 mole %) of 2-acrylamido-2-methyl propane sulphonic acid monomer.

Therefore under certain circumstances, the approaches above have provided an adequate solution to the problem of lipase activity in that: i) most of the lipase is protected; and ii) release of the lipase into wash liquor may be achieved with the benefits of lipase activity intact.

However, a further issue arises when the liquid laundry detergent formulation contains lipase enzymes and at least one ester based laundry ingredient. Ester based laundry ingredients such as polyester soil release polymers (pSRPs) are preferably used to deliver superior cleaning benefits on polyester type fabrics, especially when the liquid detergent formulations comprise low surfactant to high polymer ratios. Unfortunately, pSRPs are highly susceptible to hydrolysis by lipase enzymes present in the lipase containing detergent formulations. Once the pSRPs are digested by lipase enzymes, the cleaning benefits provided by the pSRPs are also lost, with a noticeable drop in cleaning performance. Indeed, even the presence of very small amounts of lipase enzyme may be catastrophic in terms of the stability of the pSRPs. This particular problem has not been addressed by the prior art teachings.

For example, WO2008/084093 (Novozymes) describes liquid compositions with branched copolymer matrix particles formed from vinyl pyrrolidone and vinyl acetate which encapsulate the protease enzymes and thereby protect free lipase present in the composition. The polymer matrix is insoluble in the presence of high levels of electrolytes and dissolves when the liquid composition is diluted in use. The particles therefore protect lipase present from digestion by encapsulation of the protease. However, this approach still leaves lipase free to digest other components present in the liquid composition and would therefore not facilitate inclusion of a soil release polymer susceptible to lipolytic degradation.

Likewise, WO2010/003934 (BASF/Novozymes) describes protease enzyme encapsulates prepared using a wide range of copolymers, mostly based on maleic acid or (meth)acrylic acid. In the application the protease and various copolymers are formed into particles by spray drying a mixture of the two. Reasonable protease activity remained even after storage in an aqueous detergent liquid. However, the formulation does not include lipase enzymes or polyester soil release polymers. Furthermore, the document notes that spray drying would not be expected to produce a satisfactory lipase encapsulate due to the relatively high surface activity of lipases compared with proteases leading to a significant proportion of the lipase enzyme remaining on the outside of the spray dried particle. This free lipase would then be available to attack the soil release polymer and degrade it.

An alternative approach is detailed in WO 93/22417 (Unilever) which discloses heavy duty liquid detergent compositions containing protease in the liquid and lipase protected from attack by coacervation with a PVA polystyrene copolymer. The coascervate copolymer is prevented from dissolving in the liquid by the presence of high levels of electrolyte but dissolves when diluted during use. The document makes no mention of polyester soil release polymers and the liquid detergent further contained free protease. Such coacervates are ineffective at preventing lipase from attacking soil release polymer in the liquid as the approach relies on partitioning rather than total encapsulation, lipase will therefore always be found in the liquid phase to some degree.

Likewise, in EP266796 (Showa Denko) there is described the formation of microcapsules of lipase which are stored in combination with microcapsules of protease. The microcapsules are made by cross-linking polyvinyl alcohol using boric acid. Again, lipase activity remained fairly high even in the presence of protease microcapsules and would therefore not be suitable for use with a soil release polymer in a detergent formulation. In addition, microcapsules which comprise cross-linked polyvinyl alcohol and boric acid exhibit poor dissolution kinetics.

WO 2002/081616 (Procter & Gamble) describes water-soluble or water-dispersible enzyme containing particles suitable for detergent compositions, wherein the enzyme is dispersed in a matrix comprising polyvinylalcohol. A highly preferred polymeric material is a PVA supplied by Clariant GmbH under the trade name MOWIOL, especially preferred grades of this PVA are the 3-83 grades. The low dusting particles are primarily intended for incorporation into solid detergent compositions although it is said that they may also be incorporated into high ionic strength liquid/gel compositions. The exemplified extruded particles would however be too large for use in liquids.

Finally, WO2009/153184 discloses aqueous detergent liquid compositions and a laundry method that reduces the level of in-wash surfactant used and at the same time increases the levels of polymers and enzymes present to rebalance the cleaning performance. In the composition a polyester based soil release polymer may be used, either alone or in combination with another polymer. The inclusion of the polyester based soil release polymer in the composition is intended to improve oily soil removal from polyester fabric, particularly over multiple washes. Lipase may also be included in the composition and is intended to provide a boost to oily soil removal from cotton.

Whilst it is preferable to be able to use the ester based laundry ingredients such as polyester soil release polymer and lipase enzyme together to provide improved oily soil removal across a range of natural and synthetic fabric types, in practice, achieving a stable formulation comprising these two actives has proved difficult because the polyester soil release polymers are obviously prone to attack by the lipase enzymes. Furthermore, this issue is compounded when protease enzymes are also included in the detergent formulations.

Therefore, it can be seen from the above discussion that many attempts have been made to provide an effective protective barrier around enzymes to reduce or eliminate their interaction with other ingredients in liquid detergents. Normally the enzyme selected for protection is the protease. In general, technology for forming protective capsules around protease enzymes does not solve the problem of enabling a stable and effective combination of lipase and ester based laundry ingredient such as soil release polymer to be achieved.

In addition, protection of lipase by the same techniques used to protect protease is problematic because the hydrophobic nature of lipases causes them to migrate towards the surface of the material intended to surround it. The resulting particles retain sufficient lipase activity in the composition to continue to degrade soil release polymer dissolved or suspended in the composition and the problem is made even worse if the protease is also protected because then the lipase remains in an active state for long enough to totally degrade the soil release polymer. An effective solution to this problem also needs to ensure that the lipase enzyme is capable of being released in active form when the composition is diluted.

None of the prior art documents described address the issue of providing a liquid detergent formulation which comprises lipase, protease and pSRPs which are able to deliver effective lipase and pSRP action upon dilution or suggest how this problem may be addressed.

Accordingly, there exists the need for formulators to provide liquid detergent formulations which are able to deliver excellent protease and lipase enzymatic cleaning technologies and further provide excellent ester based cleaning technologies in terms of for example the polyester soil release polymers (pSRPs).

Furthermore, there exists the need for formulators to provide liquid detergent formulations which are able to deliver excellent protease and lipase enzymatic cleaning technologies and further provide excellent ester based cleaning technologies in terms of for example the polyester soil release polymers (pSRPs) during and following storage of the formulation and which provide excellent dissolution and release of actives during the wash cycle.

It is therefore an object of the present invention to provide a liquid detergent formulation in which the lipase is protected from protease enzyme activity and which also includes co-formulation with an ester based laundry ingredient such as a polyester soil release polymer.

More specifically, it is an object of the present invention to provide a liquid detergent formulation which comprises lipase enzyme protected from protease enzymes, and which further comprises ester based laundry ingredients such as polyester soil release polymers (pSRPs) and which is able to deliver excellent protease and lipase enzymatic cleaning technologies in addition to excellent ester based cleaning technologies.

### SUMMARY OF INVENTION

According to the present invention there is provided an aqueous liquid laundry formulation comprising:
i) an ester based laundry ingredient;
ii) an effective cleaning amount of protease enzyme;
iii) an effective cleaning amount of lipase enzyme; and
iv) from 5 to 60 wt % surfactant;
characterised in that at least 70 wt % of the effective cleaning amount of lipase enzyme is encapsulated and separated from the ester based laundry ingredient and the liquid by a coating which is insoluble in the formulation but which dissolves on dilution with the wash; and wherein the laundry formulation comprises at least 20 wt % water. That is, the inventors have now found that in detergent formulations, protease enzymes attack the lipase enzymes faster than the lipase enzymes are able to attack ester based laundry ingredients. Consequently, in a formulation comprising free lipase, protease and ester based laundry ingredients (such as polyester soil release polymers), whilst the formulation retains active protease and polyester soil release polymer, lipase activity is lost. This has lead the inventors to a formulation in which the effective cleaning amount of lipase enzyme is encapsulated and separated from the ester based laundry ingredient and the aqueous liquid by a coating. That is, by encapsulation of at least 70 wt % of the effective cleaning amount of lipase enzyme, the ester based laundry ingredient is protected because any free lipase in the laundry liquid is digested by free protease in the liquid before the lipase digests the ester based laundry ingredient.

The term ‘effective cleaning amount of protease enzyme’ or ‘effective cleaning amount of lipase enzyme’ is taken herein to mean an amount of enzyme present in an aqueous liquid laundry formulation which when diluted by a least 100 times during a laundry wash, still provides a positive response to stains susceptible to protease and lipase respectively.

It will be appreciated by one skilled in the art that depending upon on the concentration of the formulation, the aqueous liquid laundry formulation may be required to be diluted at least 100 times, and even diluted as much as 200 times, 400 times or even 500 times in a wash cycle. Consequently, the term ‘effective cleaning amount of protease enzyme’ or ‘effective cleaning amount of lipase enzyme’ is taken herein to mean an amount of enzyme present in an aqueous liquid laundry formulation which when diluted by a least 100 times and if required, diluted by as much as 500 times in a wash cycle, still provides a positive response to stains susceptible to protease and lipase enzymes. That is, the present invention is applicable to aqueous liquid laundry formulations which may be concentrates as well as more dilute formulations.

Suitably an effective level of protease enzyme in the wash, as active protein, is at least 0.05 ppm. Suitably an effective level of lipase enzyme in the wash, as active protein, is at least 0.02 ppm.

As is well known in the art, positive responses to stains susceptible to either protease or lipase enzymes may be assessed using known ‘Terg-O’ tests which employ a Terg-O-Tometer, a laboratory scaled multiple washing machine used for laboratory evaluation of for example laundry liquids. Swatches of material used to evaluate lipase enzyme activity will be stained with fat prior to the Tergo-O tests and swatches of material used to evaluate protease enzyme activity will be stained with grass or blood prior to the Tergo-O tests.

The ester based laundry ingredient is preferably free. It could be encapsulated by, for example, a coating which is insoluble in the formulation but which dissolves on dilution with the wash. However, this is much less preferred because it adds to the amount of material that is not contributing to cleaning. The amounts of ester based additives such as soil release polymers, or even surfactants, are far larger than the amounts of lipase enzymes that need to be encapsulated. Furthermore, although it is essential that some protease enzyme is free, some may also be encapsulated by, for example, a coating which is insoluble in the formulation but which dissolves on dilution with the wash. However, it is preferred that the protease enzyme is free.

The coating used in accordance with the present invention to coat either, the lipase enzyme and/or the protease enzyme and/or the ester based laundry ingredient preferably comprises polyvinyl alcohol. Throughout this document, references to polyvinylalcohol include polyvinyl alcohol derivatives and/or partially hydrolysed polyvinyl alcohol unless it is explicitly stated to the contrary. Preferably the coating used in accordance with the present invention comprises anionically modified polyvinyl alcohol. More preferably, the anionic modification comprises less than 10 mol % 2-acrylamido-2-methylpropanesulphonic acid or sodium salt thereof.

Also in accordance with the present invention the aqueous liquid laundry formulation may further comprises a sequestrant. If present, the sequestrant may be present in an amount of greater than or equal to 0.01 wt %.

Also in accordance with the present invention the aqueous liquid laundry formulation further comprises a structurant. The structurant may be selected from the group comprising microfibrous cellulose (MFC), clays, laponite hydrogenated castor oils, polymers or mixtures thereof. One preferred structurant which may be used in the present invention however is citrus pulp.

Furthermore the ester based laundry ingredient preferably comprises a polyester soil release polymer. Preferably, the polyester soil release polymer comprises a poly(propylene terephthalate) midblock and endblocks comprising polyoxyethylene.

In addition, in the formulation according to the present invention the effective cleaning amount of protease enzyme is preferably not encapsulated by the coating and is instead in contact with the liquid formulation. That is the protease enzyme is free.

It is also preferred that in the formulation according to the present invention the effective cleaning amount of protease enzyme comprises hindered protease enzyme.

Further, it is preferred that in the aqueous liquid laundry formulation according to the present invention that at least 80 wt % of the effective cleaning amount of lipase enzyme is encapsulated and separated from the ester based laundry ingredient by the coating. More preferably in the aqueous liquid laundry formulation according to the present invention at least 90 wt % of the effective cleaning amount of lipase enzyme is encapsulated and separated from the ester based laundry ingredient by the coating. Most preferably, in the aqueous liquid laundry formulation according to the present invention at least 95 wt % of the effective cleaning amount of lipase enzyme is encapsulated and separated from the ester based laundry ingredient by the coating.

The formulation according to the present invention may also comprise non-protease enzymes. The non-protease enzymes when present may be encapsulated with the effective cleaning amount of lipase enzyme.

Furthermore, in the formulation according to the present invention the lipase enzyme coating such as the modified polyvinyl alcohol may comprise a thickness of greater than or equal to 5 microns. More preferably, in the formulation according to the present invention the lipase enzyme coating may comprises a thickness of greater than or equal to 8 microns. Even more preferably, in the formulation according to the present invention the lipase enzyme coating may comprises a thickness of greater than or equal to 10 microns.

### DETAILED DESCRIPTION OF THE INVENTION

### Surfactant System

Synthetic surfactants preferably form a major part of the surfactant system. Mixtures of synthetic anionic and nonionic surfactants, or a wholly anionic mixed surfactant system or admixtures of anionic surfactants, nonionic surfactants and amphoteric or zwitterionic surfactants may all be used according to the choice of the formulator for the required cleaning duty and the required dose of the detergent formulation in accordance with the present invention.

For cleaning purposes preferred surfactants assist in removing soil from textile materials or from hard surfaces and assist in maintaining removed soil in solution or suspension in water. Thus, anionic and/or nonionic surfactants are preferred.

In addition, the surfactants may be chosen from those described in ‘Surface Active Agents’ Vol. 1, by Schwartz & Perry, Interscience 1949, Vol. 2 by Schwartz, Perry & Berch, Interscience 1958, ‘McCutcheon's Emulsifiers and Detergents’ published by Manufacturing Confectioners Company or in ‘Tenside Taschenbuch’, H. Stache, 2nd Edn., Carl Hauser Verlag, 1981.

The amount of surfactant in the composition may range from 5 to 60 wt %. More preferably the amount of surfactant in the composition may range from 10 to 55 wt %. Most preferably the amount of surfactant in the composition may range from 12 to 50 wt %. It will also be appreciated by the skilled addressee that the optimum surfactant concentration will largely depend on the product type and the intended mode of use.

The anionic surfactant may also further include soap (that is, a salt of fatty acid). A preferred soap employed in detergent formulations according to the present invention is made by neutralisation of hydrogenated coconut fatty acid, for example Prifac® 5908 (ex Croda). Mixtures of saturated and unsaturated fatty acids may also be used.

Nonionic surfactants include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants used may include: alkyl polyglycosides, glycerol monoethers and polyhydroxy amides (glucamide). Mixtures of nonionic surfactant may also be used. When included therein the formulation may contain from 0.2 wt % to 40 wt % of a non-ionic surfactant. Preferably 1 wt % to 20 wt % of a non-ionic surfactant. More preferably 5 to 15 weight % of a non-ionic surfactant, selected from for example: alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Preferred nonionic surfactants that may be used include: the primary and secondary alcohol ethoxylates, especially the C₈-C₂₀ aliphatic alcohols ethoxylated with an average of from 1 to 35 moles of ethylene oxide per mole of alcohol. More especially the C₁₀-C₁₅ primary and secondary aliphatic alcohols ethoxylated with an average of from 1 to 10 moles of ethylene oxide per mole of alcohol may be used.

Examples of suitable anionic surfactants include: sodium lauryl sulfate, sodium lauryl ether sulfate, ammonium lauryl sulphosuccinate, ammonium lauryl sulfate, ammonium lauryl ether sulfate, sodium cocoyl isethionate, sodium lauroyl isethionate, and sodium N-lauryl sarcosinate. Most preferably, the synthetic anionic surfactants comprise synthetic anionic surfactant linear alkylbenzene sulfonate (LAS) or another synthetic anionic surfactant sodium alcohol ethoxy-ether sulfate (SAES) may be used, most preferably comprising high levels of sodium C₁₂ alcohol ethoxy-ether sulfate (SLES). It is however preferred that the detergent formulation according to the present invention comprises LAS.

A preferred mixed surfactant system comprises anionic with nonionic detergent active materials and optionally amphoteric surfactant, including amine oxide.

Another preferred mixed surfactant system comprises two different anionic surfactants, preferably linear alkyl benzene sulfonate and a sulfate, for example LAS and SLES.

Anionic surfactants may be present, for example, in amounts in the range from about 5% to 60 wt % of the mixed surfactant system. More preferably, anionic surfactants may be present between 10% to 55 wt % of the mixed surfactant system. Most preferably anionic surfactants may be present between 15% to 40 wt % of the mixed surfactant system.

The detergent formulation may further comprise an amphoteric surfactant, wherein the amphoteric surfactant is present in a concentration of 1 to 20 wt %. Preferably the detergent formulation comprises an amphoteric surfactant present in a concentration of 1 to 15 wt %. More preferably the detergent formulation comprises an amphoteric surfactant present in a concentration of 1 to 12 wt % of the mixed surfactant system.

Typical examples of suitable amphoteric and zwitterionic surfactants include: alkyl betaines, alkylamido betaines, amine oxides, aminopropionates, aminoglycinates, amphoteric imidazolinium compounds, alkyldimethylbetaines or alkyldipolyethoxybetaines.

### Ester Based Laundry Ingredients, or Soil Release Agents

Although the invention is particularly suitable for ensuring the survival of polymeric soil release agents it will be appreciated that other ester based ingredients that would be attacked by lipase are also protected by means of the invention. The extent to which protection is useful depends to some extent on what are the consequences of the ester bond being cleaved by action of the lipase enzyme. In the case of soil release agents this is highly destructive to their efficacy. On the other hand the resulting chemical modification of ester based perfume ingredients can possibly be overcome by modification to the perfume composition. Other detergent ingredients that are usefully employed as esters in the present invention include: Hydrogenated castor oil (a structuring material), Bleach catalysts comprising esters. Surfactants comprising esters that affect detergent properties adversely if cleaved. There are many such surfactants: for example: betaines esters, sulfosuccinates, glycinates, propionates, methyl ester ethoxylates, methyl ester sulphates, fatty acid methyl ester sulphonates, directly esterified fatty acid isethionates, ether carboxylates, ester quats and mixtures of any of the foregoing esters.

Preferred among ester based laundry ingredients are soil release agents for polyester fabrics, especially those that comprise polymers of aromatic dicarboxylic acids and alkylene glycols (including polymers containing polyalkylene glycols).

Suitable soil release polymers are described in WO 2008095626 (Clariant); WO 2006133867 (Clariant); WO 2006133868 (Clariant); WO 2005097959 (Clariant); WO 9858044 (Clariant); WO 2000004120 (Rhodia Chimie); U.S. Pat. No. 6,242,404 (Rhodia Inc); WO 2001023515 (Rhodia Inc); WO 9941346 (Rhodia Chim); WO 9815346 (Rhodia Inc); WO 9741197 (BASF); EP 728795 (BASF); U.S. Pat. No. 5,008,032 (BASF); WO 2002077063 (BASF); EP 483606 (BASF); EP 442101 (BASF); WO 9820092 (Proctor & Gamble); EP 201124 (Proctor & Gamble); EP 199403 (Proctor & Gamble); DE 2527793 (Proctor & Gamble); WO 9919429 (Proctor & Gamble); WO 9859030 (Proctor & Gamble); U.S. Pat. No. 5,834,412 (Proctor & Gamble); WO 9742285 (Proctor & Gamble); WO 9703162 (Proctor & Gamble); WO 9502030 (Proctor & Gamble); WO 9502028 (Proctor & Gamble); EP 357280 (Proctor & Gamble); U.S. Pat. No. 4,116,885 (Proctor & Gamble); WO 9532232 (Henkel); WO 9532232 (Henkel); WO 9616150 (Henkel); WO 9518207 (Henkel); EP 1099748 (Henkel); FR 2619393 (Colgate Palmolive); DE 3411941 (Colgate Palmolive); DE 3410810 (Colgate Palmolive); WO 2002018474 (RWE-DEA MINERALOEL & CHEM AG; SASOL GERMANY GMBH); EP 743358 (Textil Color AG); PL 148326 (Instytut Ciezkiej Syntezy Organicznej “Blachownia”, Pol.); JP 2001181692 (Lion Corp); JP 11193397 A (Lion Corp); RO 114357 (S. C. “Prod Cresus” S. A., Bacau, Rom.); and U.S. Pat. No. 7,119,056 (Sasol).

The most preferred soil release polymers are the water soluble/miscible or dispersible polyesters such as: linear polyesters sold under the Repel-O-Tex brand by Rhodia (gerol), lightly branched polyesters sold under the Texcare brand by Clariant, especially Texcare SRN 170, and heavily branched polyesters such as those available from Sasol and described in U.S. Pat. No. 7,119,056.

The polymeric soil release agents which may be used in the formulation of the present invention may include those soil release agents having:
(a) one or more nonionic hydrophilic components consisting essentially of:
   (i) polyoxyethylene segments with a degree of polymerization of at least 2, or
   (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or
   (iii) a mixture of oxyalkylene units comprising oxyethylene and from 1 to 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least 25% oxyethylene units and more preferably, especially for such components having 20 to 30 oxypropylene units, at least 50% oxyethylene units; or
(b) one or more hydrophobe components comprising:
   (i) C₃ oxyalkylene terephthalate segments, wherein, if said hydrophobe components also comprise oxyethylene terephthalate, the ratio of oxyethylene terephthalate:C₃ oxyalkylene terephthalate units is 2:1 or lower,
   (ii) C₄-C₆ alkylene or oxy C₄-C₆ alkylene segments, or mixtures therein,
   (iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a) (i) will have a degree of polymerization of from 200, although higher levels can be used, preferably from 3 to 150, more preferably from 6 to 100. Suitable oxy C₄-C₆ alkylene hydrophobe segments include, but are not limited to: end-caps of polymeric soil release agents such as MO₃S(CH₂)n OCH₂CH₂O—, where M is sodium and n is an integer from 4-6, as disclosed in U.S. Pat. No. 4,721,580, issued Jan. 26, 1988 to Gosselink.

Soil release agents characterized by poly (vinyl ester) hydrophobe segments include: graft copolymers of poly (vinyl ester), for example, C₁-C₆ vinyl esters, preferably poly(vinyl acetate) grafted onto polyalkylene oxide backbones, such as polyethylene oxide backbones, as described in EP 0 219 048. Commercially available soil release agents of this kind include the SOKALAN type of material, e.g., SOKALAN HP-22 available from BASF (West Germany).

One type of preferred soil release agent is a copolymer having random blocks of ethylene terephthalate and polyethylene oxide (PEO) terephthalate. The molecular weight of this polymeric soil release agent is in the range of from about 25,000 to about 55,000 as described in U.S. Pat. No. 3,959,230 and U.S. Pat. No. 3,893,929.

Another preferred polymeric soil release agent is a polyester with repeat units of ethylene terephthalate units contains 10 to 15% by weight of ethylene terephthalate units together with 80 to 90% by weight of polyoxyethylene terephthalate units, derived from a polyoxyethylene glycol of average molecular weight 300-5,000. Examples of this polymer are described in U.S. Pat. No. 4,702,857.

Another preferred polymeric soil release agent is a sulfonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451. Other suitable polymeric soil release agents include the terephthalate polyesters described in U.S. Pat. No. 4,711,730, the anionic end-capped oligomeric esters described in U.S. Pat. No. 4,721,580, and the block polyester oligomeric compounds described in U.S. Pat. No. 4,702,857.

Preferred polymeric soil release agents also include the soil release agents of U.S. Pat. No. 4,877,896, which discloses anionic, especially sulfoarolyl, end-capped terephthalate esters.

The soil release agents will generally comprise from about 0.01% to about 10.0%, by weight, of the detergent formulation. Typically the soil release agents will generally comprise greater than or equal to 0.2 wt % of the detergent formulation. More preferably however, the soil release agents will generally comprise greater than 1 wt % of the detergent formulation, even, greater than 2 wt % of the detergent formulation and most preferably greater than 3 wt % of the detergent formulation.

In addition, for improved compatibility with detergent formulations and improved resistance to hydrolysis during storage in alkaline aqueous compositions, a nonionic polyester soil release polymer may be used of structure (I)

E-M-L-E, (I)

where the midblock M is connected to a generally hydrophilic end block E and blocks E each comprise capped oligomers of polyethylene glycol remote from the midblock, with at least 10 EO (ethylene oxide) repeat units, the end blocks being free from ester bonds, either directly or via linking moiety L which comprises the motif:

B—Ar—B

where B is selected from ester moieties and Ar is 1,4 phenylene,
and midblock M comprises the motif:

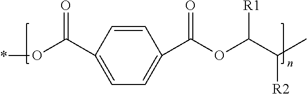

wherein R1 and R2 may be the same or different and are selected from: C₁-C₄ alkyl, C₁-C₄ alkoxy and hydrogen, provided that R1 and R2 may not both be hydrogen, n is at least 2, preferably more than 5, the ester bonds may be formed the other way around (not shown), if they are so reversed then all of them will be so reversed as described in WO2012/104159.

### Enzymes

### Protease Enzyme

The protease enzyme for use in the formulation of the present invention may be supplied in admixture with an enzyme inhibitor. A suitable inhibitor is 4FPB4. Suitable proteases for use in the present invention include those of animal, vegetable or microbial origin. Microbial origin is preferred. Chemically modified or protein engineered mutants are included. The protease may be a serine protease or a metallo protease, preferably an alkaline microbial protease or a trypsin-like protease. Preferred commercially available protease enzymes include: Alcalase™, Savinase™, Primase™, Duralase™, Dyrazym™, Esperase™, Everlase™, Polarzyme™, and Kannase™, (Novozymes A/S), Maxatase™, Maxacal™, Maxapem™, Properase™, Purafect™, Purafect OxP™, FN2™, and FN3™ (Genencor International Inc.).

An effective amount of protease enzyme may be described as sufficient to provide a significant cleaning benefit on a protease sensitive stain like grass or blood. Protease protein (as opposed to raw protease) is typically supplied at levels of around 0.02 wt % in a 35 ml dose product formulation. An effective cleaning amount of protease enzyme may therefore be defined as a minimum level of 0.001 wt % protease enzyme protein in an aqueous detergent liquid formulation.

### Lipase Enzyme

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1 131, 253-360), B. stearothermophilus (JP 64/744992) or B. pumilus (WO 91/16422). Preferred ones have a high degree of homology with the wild-type lipase derived from Humicola lanuginosa. Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include Lipolase™ and Lipolase Ultra™, Lipex™ and Lipoclean™ (Novozymes A/S). Also Lipomax™ a lyophilized lipase-preparation from pseudomonas alcaligenes (originally from Gist-brocades, more recently from the Genencor division of Danisco).

Lipase is preferably included in an aqueous liquid detergent formulation in an amount of from 0.001 to 0.3 wt % active enzyme protein in a 35 ml dose product formulation. Advantageously, the presence of relatively high levels of calcium in poorly built or unbuilt wash liquors has a beneficial effect on the turnover of certain enzymes, particularly lipase enzymes and preferably lipases from Humicola.

The preferred lipases include first wash lipases which comprise a polypeptide having an amino acid sequence which has at least 90% sequence identity with the wild-type lipase derived from Humicola lanuginosa strain DSM 4109 and compared to said wild-type lipase, comprises a substitution of an electrically neutral or negatively charged amino acid within 15 A of E1 or Q249 with a positively charged amino acid; and may further comprise: (I) a peptide addition at the C-terminal; (II) a peptide addition at the N-terminal; (III) meets the following limitations:
i. comprises a negatively charged amino acid in position E21 0 of said wild-type lipase;
ii. comprises a negatively charged amino acid in the region corresponding to positions 90-1 01 of said wild-type lipase; and
iii. comprises a neutral or negatively charged amino acid at a position corresponding to N94 of said wild-type lipase; and/or
iv. has a negative charge or neutral charge in the region corresponding to positions 90-101 of said wild-type lipase; and
v. mixtures thereof.

These are available under the Lipex™ brand from Novozymes. A similar enzyme from Novozymes, but believed to fall outside of the above definition, is made available by Novozymes under the name Lipoclean™ and this is also preferred.

The lipase for use in the formulation of the present invention is preferably a so called first wash lipase. Suitable lipases for use in the present invention include Lipex and Lipoclean.

An effective amount of lipase enzyme may be described as a minimum level of about 0.001 wt % lipase enzyme protein in an aqueous detergent liquid formulation or a level that is sufficient to provide a statistical benefit on a lipase sensitive stain such as Lard when subject to Terg-O tests.

### Coated Enzyme Particles

As mentioned above, the lipase enzyme in the formulation of the present invention is preferably separated from the ester based laundry ingredient and detergent liquid by encapsulation.

The enzyme may be supplied in the form of granules which are encapsulated inside a sealed PVOH sachet before inclusion in the aqueous liquid detergent formulation. Alternatively, the enzyme granules are placed in a fluid bed coating device for encapsulation. Alternatively, the enzyme may be supplied in porous starch beads. The beads are then coated using a fluidized bed spray coater.

Any type of enzyme particle may be used so long as it is able to be coated using fluid bed coating and retained within the coating. Such particles include but are not limited to: agglomerated particles, porous impregnated particles or matrix particles.

Coated enzyme particles of lipase and/or protease enzymes may be produced using any of the known processes, for example spray drying, spray coating, precipitation/coascervation and freeze drying. For larger particles the coating may be preformed and then the enzyme inserted into it, for example by folding a polymer film around the enzyme granule and sealing the edges.

The polymers are preferably designed so that the packaged and encapsulated products are released from the package or capsule after the polymer is placed in and dissolves in water or an aqueous solution. The water-soluble polymers are preferably copolymers of vinyl alcohol units and sulfonic acid units selected from for example, 2-acrylamido-2-methyl propane sulfonic acid; 2-methacrylamido-2-methyl propane sulfonic acid, and combinations thereof. The copolymers are produced at molecular weights and monomer incorporation levels providing aqueous solubility characteristics in the presence of liquid detergent formulations. Consequently, the copolymers are particularly useful for packaging detergent formulations and encapsulating detergent components such as enzymes. In relation to the present invention the copolymers may be sprayed or misted onto the enzyme particles to provide a polymeric coating encapsulating the particles.

The copolymers described above may be used to produce films that may be in the form of a package or coating. The films may comprise 100 parts by weight of a first component selected from a copolymer comprised of vinyl alcohol units and sulfonic acid units selected from 2-acrylamido-2-methyl propane sulfonic acid; 2-methacrylamido-2-methyl propane sulfonic acid, and combinations thereof and wherein the film comprises less than 0.05 parts by weight of a second component selected from the group consisting of gallic acid, salts of gallic acid, C₁₋₅ alkyl esters, and combinations thereof.

The 2-acrylamido-2-methyl propane sulfonic acid and 2-methacrylamido-2-methyl propane sulfonic acid monomers are particularly useful for incorporation into the copolymers described herein. Copolymers incorporating the 2-acrylamido-2-methyl propane sulfonic acid and 2-methacrylamido-2-methyl propane sulfonic acid monomers may be readily produced in a variety of molecular weights and monomer levels and are easily hydrolyzed. Moreover, the copolymers maintain the excellent mechanical properties exhibited by polyvinyl alcohol.

In addition to the sulfonic acid comonomer incorporated into the polyvinyl alcohol copolymers described herein, the copolymers described herein may also incorporate one or more other comonomers, so long as the performance of the coating is not impaired. The copolymers described herein are capable of being converted into pouches and coatings and exhibit storage stability while also being capable of dissolving rapidly in water over an acceptable temperature range for laundry compositions. In addition, the film coatings are not deleterious to cleaning performance when used to package or coat detergents and detergent components.

Whilst not limited thereto, the copolymers may be produced by producing a precursor vinyl acetate copolymer. The synthesis of the precursor vinyl acetate copolymer may be conducted in solution, slurry, suspension or emulsion type polymerizations. Rodriguez, in “Principles of Polymer Systems”, p. 98-101, 403, 405 (McGraw-Hill, N Y, 1970) describes bulk and solution polymerization and the specifics of emulsion polymerization. When preparing poly(vinyl acetate) by suspension polymerization for example, the monomer is typically dispersed in water containing a suspending agent such as polyvinyl alcohol and then an initiator such as peroxide is added. The unreacted monomer is removed and the polymer filtered and dried.

The enzyme particles typically range in size from 20 microns to 2000 microns. The particles are preferably coated with the polyvinyl alcohol copolymers described herein by exposing the particles to a solution of the copolymers in a fluidized bed spray coater.

The copolymers may be coated by application in an aqueous solution containing in the region of 5 wt % copolymer. In certain embodiments, the coating composition is an aqueous solution incorporating in the region of 1 wt % to 10 wt % copolymer. In still other embodiments, the coating composition is an aqueous solution incorporating in the region of 3 wt % to 7 wt %.

The thickness of the copolymer coating may be varied as a result of the time that the particles remain in the fluidized bed spray coater.

Preferably, the thickness of the copolymer varies from 5 to 100 nm.

### Additional Enzymes

In addition to the one or more lipase and protease enzymes used in the formulation of the present invention, one or more further enzymes may be present. The further enzymes may be selected from classes of enzyme known to be compatible with surfactant containing formulations, and preferably comprise one or more of proteases, lipases, mannanases and amylases.

### Cellulase:

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola+-insolens, Thielavia terrestris, Myceliophthora thermophila, and Fusarium oxysporum disclosed in U.S. Pat. No. 4,435,307, U.S. Pat. No. 5,648,263, U.S. Pat. No. 5,691,178, U.S. Pat. No. 5,776,757, WO 89/09259, WO 96/029397, and WO 98/012307. Commercially available cellulases include Celluzyme™, Carezyme™, Endolase™, Renozyme™ (Novozymes A/S), Clazinase™ and Puradax HA™ (Genencor International Inc.), and KAC-500(B)™ (Kao Corporation).

### Pectate Lyase:

Examples of pectate lyases (also called polygalacturonate lyases) include pectate lyases that have been cloned from different bacterial genera such as Erwinia, Pseudomonas, Klebsiella and Xanthomonas, as well as from Bacillus subtilis (Nasser et al. (1993) FEBS Letts. 335:319-326) and Bacillus sp. YA-14 (Kim et al. (1994) Biosci. Biotech. Biochem. 58:947-949). Purification of pectate lyases with maximum activity in the pH range of 8-10 produced by Bacillus pumilus (Dave and Vaughn (1971) J. Bacteriol. 108:166-174), B. polymyxa (Nagel and Vaughn (1961) Arch. Biochem. Biophys. 93:344-352), B. stearothermophilus (Karbassi and Vaughn (1980) Can. J. Microbiol. 26:377-384), Bacillus sp. (Hasegawa and Nagel (1966) J. Food Sci. 31:838-845) and Bacillus sp. RK9 (Kelly and Fogarty (1978) Can. J. Microbiol. 24:1 164-1 172) have also been described. Any of the above, as well as divalent cation-independent and/or thermostable pectate lyases, may be used. The pectate lyase may preferably comprise the pectate lyase disclosed in Heffron et al., (1995) Mol. Plant-Microbe Interact. 8: 331-334 and Henrissat et al., (1995) Plant Physiol. 107: 963-976. Specifically contemplated pectate lyases are disclosed in WO 99/27083 and WO 99/27084. Other specifically contemplated pectate lyases (derived from Bacillus licheniformis) are disclosed in U.S. Pat. No. 6,284,524. Specifically contemplated pectate lyase variants are disclosed in WO 02/006442, especially the variants disclosed in the Examples in WO 02/006442. Examples of commercially available alkaline pectate lyases include BIOPREP™, SCOURZYME™ L and Xpect™ from Novozymes A/S, Denmark.

### Phospholipase:

Phospholipase may be classified as EC 3.1.1.4 and/or EC 3.1.1.32. As used herein, the term phospholipase is an enzyme that has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes that participate in the hydrolysis of phospholipids. Several types of phospholipase activity can be distinguished, including phospholipases A1 and A2 which hydrolyze one fatty acyl group (in the sn-1 and sn-2 position, respectively) to form lysophospholipid; and lysophospholipase (or phospholipase B) which can hydrolyze the remaining fatty acyl group in lysophospholipid.

Phospholipase C and phospholipase D (phosphodiesterases) release diacyl glycerol or phosphatidic acid respectively.

### Cutinase:

Cutinase is classified in EC 3.1.1.74. The cutinase may be of any origin.

Preferably cutinases are of microbial origin, in particular of bacterial, of fungal or of yeast origin.

### Amylase:

Suitable amylases (alpha and/or beta) include those of bacterial or fungal origin.

Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

### Peroxidase/Oxidase:

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

### Mannanase:

Examples of mannanases (EC 3.2.1.78) include mannanases of bacterial and fungal origin. The mannanase may be derived from a strain of the filamentous fungus genus Aspergillus, preferably Aspergillus niger or Aspergillus aculeatus (WO 94/25576). WO 93/24622 discloses a mannanase isolated from Trichoderma reseei. Mannanases have also been isolated from several bacteria, including Bacillus organisms. For example, Talbot et al., Appl. Environ. Microbiol., Vol. 56, No. 1 1, pp. 3505-3510 (1990) describes a beta-mannanase derived from Bacillus stearothermophilus. Mendoza et al., World J. Microbiol. Biotech., Vol. 10, No. 5, pp. 551-555 (1994) describes a beta-mannanase derived from Bacillus subtilis. JP-A-03047076 discloses a beta-mannanase derived from Bacillus sp. JP-A-63056289 describes the production of an alkaline, thermostable beta-mannanase. JP-A-63036775 relates to the Bacillus microorganism FERM P-8856 which produces beta-mannanase and beta-mannosidase. JP-A-08051975 discloses alkaline beta-mannanases from alkalophilic Bacillus sp. AM-001. A purified mannanase from Bacillus amyloliquefaciens is disclosed in WO 97/11164. WO 91/18974 describes a hemicellulase such as a glucanase, xylanase or mannanase active.

Contemplated are the alkaline family 5 and 26 mannanases derived from Bacillus agaradhaerens, Bacillus licheniformis, Bacillus halodurans, Bacillus clausii, Bacillus sp., and Humicola insolens disclosed in WO 99/64619. Especially contemplated are the Bacillus sp. mannanases used in the Examples of WO 99/64619.

Examples of commercially available mannanases include Mannaway™ available from Novozymes A/S Denmark.

### Perhydrolase:

Suitable perhydrolases are capable of catalyzing a perhydrolysis reaction that results in the production of a peracid from a carboxylic acid ester (acyl) substrate in the presence of a source of peroxygen (for example, hydrogen peroxide). While many enzymes perform this reaction at low levels, perhydrolases exhibit a high perhydrolysis:hydrolysis ratio, often greater than 1. Suitable perhydrolases may be of plant, bacterial or fungal origin. Chemically modified or protein engineered mutants are included.

Examples of useful perhydrolases include naturally occurring Mycobacterium perhydrolase enzymes, or variants thereof. An exemplary enzyme is derived from Mycobacterium smegmatis. Such enzyme, its enzymatic properties, its structure, and variants thereof, are described in WO 2005/056782, WO 2008/063400, US 2008/145353, and US2007167344.

Enzymes present in the composition may be stabilized using conventional stabilizing agents, for example, a polyol such as propylene glycol or glycerol, a sugar or sugar alcohol, lactic acid, boric acid, or a boric acid derivative, for example, an aromatic borate ester, or a phenyl boronic acid derivative such as 4-formylphenyl boronic acid, and the composition may be formulated as described in e.g. WO 92/19709 and WO 92/19708.

### External Structuring System/Structurant

As used herein, the term “external structuring system” or external structurant refers to a selected compound or mixture of compounds which provide either a sufficient yield stress or low shear viscosity to stabilize the fluid laundry detergent formulation independently from, or extrinsic from, any structuring effect of the detersive surfactants of the formulation.

The term “Structured Liquid Detergents” means a liquid detergent that has a yield stress of at least 0.15 Pa so that it is capable of suspending a coated enzyme particle or matrix particle. The yield stress may effectively be defined as the stress at a shear rate of 0.1(1/s).

External structuring systems/external structurants are those which impart a sufficient yield stress or low shear viscosity to stabilize the fluid laundry detergent formulation independently from, or extrinsic from, any structuring effect of the detersive surfactants of the composition. Preferably, the external structuring system/external structurant imparts to the fluid laundry detergent formulation a high shear viscosity at 20 sec-1 at 21° C. of from 1 to 1500 cps and a viscosity at low shear (0.05 sec-1 at 21° C.) of greater than 5000 cps. The viscosity is measured using an AR 550 rheometer from TA instruments using a plate steel spindle at 40 mm diameter and a gap size of 500 μm. The high shear viscosity at 20^{s-1} and low shear viscosity at 0.5-1 may be obtained from a logarithmic shear rate sweep from 0.1-1 to 25-1 in 3 minutes time at 21° C.

The formulation of the present invention preferably comprises from 0.05% to 2% by weight of an external structurant. More preferably the formulation of the present invention comprises from 0.1% to 1% by weight of an external structurant.

The external structuring system may comprise hydrogenated castor oil or “HCO”. HCO as used herein may be any hydrogenated castor oil or derivative thereof. Castor oils may include: glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, for example, hydroxystearyl. The HCO herein may, in some embodiments, be selected from: trihydroxystearin; dihydroxystearin; and mixtures thereof. The HCO may be processed in any suitable starting form, including, but not limited to those selected from solid, molten and mixtures thereof. HCO is typically present at a level of from 2% to 10%, from 3% to 8%, or from 4% to 6% by weight in the external structuring system. In some embodiments, the corresponding percentage of hydrogenated castor oil delivered into a finished laundry detergent product is below 1.0%, typically from 0.1% to 0.8%.

HCO of use in the present invention includes those that are commercially available. Non-limiting examples of commercially available HCO of use in the present invention include: THIXCIN® from Rheox, Inc. Further examples of useful HCO may be found in U.S. Pat. No. 5,340,390.

While the use of hydrogenated castor oil is preferred, any crystallisable glyceride can be used within the scope of the invention. Preferred crystallisable glyceride(s) have a melting point of from 40° C. to 100° C.

An alternative structurant employed in detergent applications is citrus fibre. Compositions comprising citrus fibre and the use of same in foodstuffs and personal care compositions are described in US2004/0086626 and US2009/269376.

Using citrus fibre as a structurant in structured liquid detergents offers the advantage that the citrus fibre is compatible with cleaning and care enzymes, as described in PCT/EP2011/067549. The use of citrus fibre in combination with a cationic deposition polymer (Jaguar quaternised guar gum) is disclosed in WO2012/019934, and U.S. Pat. No. 7,981,855 discloses detergent liquid surfactant compositions comprising up to 15 wt % surfactant, including at least 1 wt % anionic surfactant and from 0.001 to 5 wt % citrus fibres.

A preferred type of powdered citrus fibre for detergent compositions and used in accordance with the present invention is available from Herbafoods under the tradename, Herbacel™ AQ+ type N citrus fibre. This citrus fibre has a total (soluble and insoluble) fibre content of greater than 80% by weight and soluble fibre content of greater than 20% by weight. It is supplied as a fine dried powder with low colour and has a water binding capacity of about 20 kg water per kg of powder.

To obtain adequate structure, powdered citrus fibre is activated (hydrated and opened up structurally) via a high shear dispersion process at a low concentration in water when forming the premix of the present invention. It is advantageous to include a preservative into the premix as the dispersed activated citrus fibre is biodegradable.

It is desirable that the shear applied to the citrus fibre should not be so high as to lead to defibrillation. Consequently, if a high-pressure homogeniser is used, it is preferably operated between 50 and 1000 barg, more preferably, between 100 and 700 barg. Most preferably the high-pressure homogeniser is activated between 300 and 500 barg. The more shear that is applied the less dense the resulting particles. Whilst the morphology is changed by the high shear, process aggregate size appears not to be changed. Instead, the fibres breakdown and then fill the water phase. The shearing process also loosens the outer parts of the fruit cell walls and these are able to form a matrix that structures the water outside of the volume of the original fibre.

The level of activated citrus fibre in a premix prepared in accordance with the present invention preferably lies in the range of 0.2 to 6 wt %. More preferably the level of activated citrus fibre in a premix prepared in accordance with the present invention preferably lies in the range of 0.5 to 4 wt %. Most preferably the level of activated citrus fibre in a premix prepared in accordance with the present invention preferably lies in the range of 1 to 3 wt %.

The level of citrus pulp inclusion in the detergent liquid is preferably in the range 0.01% to 2 wt %. More preferably the level of citrus pulp in the detergent liquid is 0.05% to 0.5%. Most preferably level of citrus pulp in the detergent liquid is 0.04% to 0.3 wt % in formulation.

It will however be apparent to a skilled reader that the concentration of activated citrus fibre in the premix depends on the ability of the equipment to deal with the higher viscosity especially at higher concentrations.

Preferably the amount of water in the premix is at least 20 times greater than the amount of citrus fibres. More preferably the amount of water in the premix is at least at least 25 times the amount of citrus fibres. Even more preferably the amount of water in the premix is as much as 50 times the amount of citrus fibres. It is also advantageous that there is excess water in order to hydrate the activated citrus fibre fully. Preferred premixes have a measured yield stress of at least 70 Pa measured using an Anton Paar serrated cup and bob geometry at 25° C.

Preferred yield stress ranges for the activated citrus pulp premix are 50 to 250 Pa; more preferably the yield stress ranges is 70 to 200 Pa, most preferred is 80 to 180 Pa.

When added to a liquid detergent composition activated citrus fibre boosts the yield stress and the pour viscosity of the composition at 21 s⁻¹ and the composition is referred to as a shear thinning liquid. Yield stress and viscosity at 21 s⁻¹ increase generally in line with the level of activated citrus fibre.

Citrus fibre has the further advantage that it is compatible with enzymes used in laundry and household care detergent compositions.

Further suitable external structurants for use in the present invention include clays and polymers. External structurants may be combined as used together.

### Sequestrants

It is desirable to include water-soluble sequestrants in the formulation of the invention. Phosphonate sequestrants are preferred. When included the sequestrants are advantageously used at levels of from 0.3 to 3 wt % of the formulation. A preferred sequestrant is HEDP (1-Hydroxyethylidene-1,1,-diphosphonic acid), available as DEQUEST® 2010 from Thermphos. It should be noted that any sequestrant may be kept suspended and dispersed by an external structurant as described above. A similar point may be made about soil release polymers and any other ingredients that are used near to or over the limit of their solubility.

### Enzyme Stabilizers

Any enzyme present in the formulation may be stabilized using conventional stabilizing agents, for example, a polyol such as propylene glycol or glycerol, a sugar or sugar alcohol, lactic acid, boric acid, or a boric acid derivative, for example, an aromatic borate ester, or a phenyl boronic acid derivative such as 4-formylphenyl boronic acid, and the composition may be formulated as described in for example, WO 92/19709 and WO 92/19708.

### Water

The detergent formulations prepared in accordance with the present invention are aqueous and water forms the majority of the solvent in the composition. Additional hydrotropes such as propylene glycol, glycerol, glycerine and mixtures thereof may also be included as co-solvents to a lesser extent than the water solvent. Water is required in the formulation in order to keep other components of the composition such as for example, surfactants, polymers, soluble builders, enzymes etc in solution. The water referred to in the formulation includes both free water and any bound water. The amount of water in the composition is preferably at least 20 wt %. More preferably the amount of water in the composition is at least 30 wt % and even at least 50%. Additional hydrotropes, when used, are preferably present at levels of from 1 to 20 wt % of the formulation.

### pH Adjustment

The composition may further comprise MEA and/or TEA and/or sodium hydroxide for alkalinity (neutralisation and buffering).

### Brighteners

Optical brighteners or other brightening or whitening agents known in the art may also be incorporated at levels typically from about 0.05% to about 1.2%, by weight, into the liquid detergent formulations.

Commercial optical brighteners, which may be useful in the present invention, may be classified into subgroups, which include, but are not necessarily limited to: derivatives of stilbene, pyrazoline, cournarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

### Fabric Softeners

Various through-the-wash fabric softeners, such as the smectite clays of U.S. Pat. No. 4,062,647, as well as other softener clays known in the art, may optionally be used in the process of the present invention, typically at levels of from 0.5% to 10 wt % to provide fabric softener benefits concurrently with fabric cleaning. Clay softeners may also be used in combination with amine and cationic softeners as disclosed, for example, in: U.S. Pat. No. 4,375,416 and U.S. Pat. No. 4,291,071

### Dye Transfer Inhibiting Agents

The formulations prepared according to the process of the present invention may also include one or more materials for inhibiting the transfer of dyes from one fabric to another during the cleaning process. Generally, such dye transfer inhibiting agents are selected from the groups consisting of: polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from 0.01% to 10 wt % of the formulation. Preferably the agents comprise from 0.01% to 5 wt %. More preferably the agents comprise from 0.05% to 2 wt %.

The liquid detergent formulations according to the present invention are preferably concentrated liquid cleaning compositions. The liquid compositions have a physical form, which ranges from a pourable liquid, a pourable gel to a non-pourable gel. These forms are conveniently characterised by the product viscosity. In these definitions, and unless indicated explicitly to the contrary, throughout this specification, all stated viscosities are those measured at a shear rate of 21 s⁻¹ and at a temperature of 25° C. This shear rate is the shear rate that is usually exerted on the liquid when poured from a bottle. The liquid detergent formulations made according to the invention are shear-thinning liquids. Pourable liquid detergent formulations preferably have a maximum viscosity of 1,500 mPa·s. More preferably liquid detergent formulations have a viscosity of not more than 1,000 mPa·s. Typically, the viscosity is lower than 1000 mPa·s at 21 s⁻¹.

Liquid detergent formulations which are pourable gels, preferably have a viscosity of at least 1,500 mPa·s but no more than 6,000 mPa·s. More preferably liquid detergent formulations which are pourable gels, have a viscosity of no more than 4,000 mPa·s. Still more preferably liquid detergent formulations which are pourable gels have a viscosity of no more than 3,000 mPa·s and especially no more than 2,000 mPa·s.

Non-pourable gels preferably have a viscosity of at least 6,000 mPa·s but no more than 12,000 mPa·s. More preferably non-pourable gels have a viscosity of no more than 10,000 mPa·s. Still more preferably non-pourable gels have a viscosity of no more than 8,000 mPa·s and especially not more than 7,000 mPa·s.

For the purpose of the invention a formulation is considered physically stable when it remains homogeneous with dispersed and suspended perfume encapsulates over a period of 3 months at temperatures from 5 to 37° C.

### Perfume

It is advantageous to ensure that any perfume used in the formulation is employed efficiently. Encapsulated perfumes may be utilized to deploy perfume. Use of a perfume that is encapsulated reduces the amount of perfume vapour that is produced by the formulation before it is diluted. This is important when the perfume concentration is increased to allow the amount of perfume per wash to be kept at a reasonably high level.

It is even more preferable that the perfume is not only encapsulated but also that the encapsulated perfume is provided with a deposition aid to increase the efficiency of perfume deposition and retention on fabrics. The deposition aid is preferably attached to the encapsulate by means of a covalent bond, entanglement or strong adsorption, preferably by a covalent bond or entanglement.

### Optional Ingredients

Usual ingredients that may be found in detergent liquids and among which there may be mentioned, by way of example: polymeric thickeners; detergency builders; hydrotropes; neutralising and pH adjusting agents; optical brighteners; antioxidants and other preservatives, such as antimicrobial agents including Proxel®; other active ingredients, processing aids, dyes or pigments, carriers, fragrances, suds suppressors or suds boosters, chelating agents, clay soil removal/anti-redeposition agents, fabric softeners, dye transfer inhibition agents, and transition metal catalyst in a composition substantially devoid of peroxygen species.

These and further possible ingredients for inclusion in the present invention are further described in WO 2009/153184 and are incorporated herein by reference.

### Packaging

The formulations may be packaged in any form of container. Typically a plastic bottle with a detachable closure/pouring spout. The bottle may be rigid or deformable. A deformable bottle allows the bottle to be squeezed to aid dispensing. If clear bottles are used they may be formed from PET. Polyethylene or clarified polypropylene may be used. Preferably the container is clear enough that the liquid, with any visual cues therein, is visible from the outside. The bottle may be provided with one or more labels, or with a shrink wrap sleeve which is desirably at least partially transparent, for example 50% of the area of the sleeve may be transparent. The adhesive used for any transparent label should not adversely affect the transparency.

In addition, the formulations may be packaged in a container which provides a unit dose, or may comprise single or multiple compartments.

The invention will now be further described with reference to the following non-limiting examples.

### Experimental Section

### Abbreviations and Reagents

LAS acid is C₁₂₋₁₄ linear alkylbenzene sulphonic acid.
Fatty acid is saturated lauric fatty acid Palmera B1231/Prifac® 5908 ex Croda.
SLES 3EO is sodium lauryl ether sulfate with 3 moles ethylene oxide.
Empigen® BB is an alkyl betaine ex Huntsman (Coco dimethyl carbobetaine).
Empigen® OB is an amine oxide ex Huntsman.
NI 7EO is C₁₂₋₁₅ alcohol ethoxylate 7EO nonionic Neodol® 25-7 (ex Shell Chemicals).
MPG is mono propylene glycol.
TEA is triethanolamine.
NaOH is sodium hydroxide (from 47% solution).
EPEI is Sokalan HP20-ethoxylated polyethylene imine cleaning polymer: PEI(600) 20EO ex BASF.
Dequest® 2010 is HEDP (1-Hydroxyethylidene-1,1,-diphosphonic acid).
Texcare SRN is a polyester soil release polymer ex Clariant.
MEA is monoethanolamine.
Proxel GLX is antimicrobial preservative, a 20% solution of 1,2 benzisothiazolin-3-one in dipropylene glycol and water ex Arch Biocides.
Lipex™ 100T lipase enzyme, ex Novozymes
Savinase™ TXT protease enzyme, ex Novozymes.

### Experiment 1

Experiment 1, was performed to demonstrate that a capsule comprising polyvinyl alcohol was able to protect lipase enzyme in a liquid formulation that also contains protease enzyme. Different combinations of free enzymes and polyvinyl alcohol encapsulated enzymes were added to a laundry liquid detergent formulation as detailed in Table 1. Samples were taken from each of the seven different combinations listed in Table 2 at time T=0 weeks and time T=2 weeks and the lipase activity for each sample measured.

The lipase enzyme used was Lipex™ 100T ex Novozymes. The protease enzyme used was Savinase™ TXT ex Novozymes. The enzyme capsules and/or free enzymes were stored at 37° C. for 2 weeks in screw-capped vials containing 20 ml of laundry liquid formulation.

TABLE 1
laundry liquid detergent formulation

| | | Wt % |
|---|---|---|
| Ingredient | Function | (100% solids) |
| Demineralised water | Solvent | 39.03 |
| MPG | Hydrotrope | 20.00 |
| NaOH | Neutralisation | 0.50 |
| TEA | Neutralisation | 3.50 |
| NI 7EO | Ethoxylated fatty alcohol | 12.74 |
| | Surfactant (nonionic) | |
| LAS acid | Alkyl benzene sulfonate | 8.49 |
| | Surfactant (anionic non | |
| | soap) | |
| SLES 3EO | Surfactant (anionic non | 4.24 |
| | soap) | |
| Empigen ® BB | Surfactant (amphoteric | 1.50 |
| | betaine) | |
| Fatty acid | Surfactant (anionic soap) | 1.50 |
| EPEI | Cleaning Polymer | 5.50 |
| pH adjustment | 8.5 ± 0.5 | 3.00 |

### Enzyme Activity Assays of Enzyme/PVOH Capsules

After two weeks the enzyme/laundry liquid formulations were taken from storage and tested for enzyme activity (as with the T=0 weeks samples), by adding the contents of each vial separately to 2 litres of tap water. The enzymes were released into the water and the lipase activity was measured using a p-nitrophenyl (pNP)-caprylate lipase assay for each of the two week old samples.

For the lipase enzyme assay, 20 μl of the released diluted enzyme sample was added to each well of a standard microtitre plate. To this sample was then added 100 μl of 50 mM tris-hydrochloride-sodium hydroxide buffer, pH 8.5; 60 μl water and 20 μl of 1 mM pNP-caprylate substrate in 10% methanol, pH 4.5 in a microtitre plate. The lipase activity was measured by monitoring the release of free p-nitrophenol at 405 nm over a 15 minute incubation period at room temperature. The results are provided in Table 2.

Linear slopes derived from these assays were used to calculate residual lipase activities remaining as a percentage based on a 100% value at T=0 weeks.

TABLE 2

| | | Residual |
|---|---|---|
| | | Lipase Activity |
| Sample | | at 37° C. after |
| number | Sample Description | 2 weeks (%) |
| 1 | Lipase enzyme in capsule/no protease enzyme | 88.3 |
| | present | |
| 2 | Free lipase enzyme/no protease enzyme present | 43.8 |
| 3 | Free Lipase enzyme/Free Protease enzyme | 0 |
| 4 | Lipase enzyme and protease enzyme in same | 0 |
| | capsule | |
| 5 | Free lipase enzyme/Protease enzyme in capsule | 26.4 |
| 6 | Lipase enzyme in capsule/Protease enzyme in | 65.6 |
| | liquid | |
| 7 | Lipase enzyme in capsule/Protease enzyme in | 73.9 |
| | capsule | |

As may be seen from Table 2, samples 2, 3 and 5 with free lipase suffered considerable loss of lipase activity. Sample 5 is noteworthy as it appears that putting protease enzyme in a capsule does not provide adequate protection for the lipase. Samples 6 and 7 still demonstrated effective lipase activity.

### Experiment 2

was performed to investigate if lipase enzyme renders polyester soil release polymer present in the liquid inactive. In experiment 2, it was investigated if a polyester soil release polymer and lipase present in a detergent formulation are both still active after storage in the presence of protease enzyme, provided a PVOH capsule is used. The laundry liquid detergent formulation used for experiment 2 is given in Table 3.

TABLE 3
laundry liquid detergent formulation

| | | weight % |
|---|---|---|
| Ingredient | Function | (100% solids) |
| Demineralised water | Solvent | 37.67 |
| MPG | Hydrotrope | 15.00 |
| MEA | Neutralisation (to pH 6.5) | 1.88 |
| TEA | Neutralisation | 3.50 |
| NI 7EO | Ethoxylated fatty alcohol | 12.74 |
| | Surfactant (nonionic) | |
| LAS acid | Alkyl benzene sulfonate Surfactant | 8.49 |
| SLES 3EO | Surfactant | 4.24 |
| Empigen ® OB | Surfactant (amine oxide) | 1.50 |
| Fatty acid | Surfactant (anionic soap) | 1.50 |
| Dequest ® 2010 | Sequestrant | 2.62 |
| EPEI | Polymer | 5.50 |
| Texcare SRN | Polyester soil release polymer | 3.75 |
| Proxel GLX | Preservative | 0.016 |
| Perfume | Free oil | 1.49 |
| Fluorescer | | 0.1 |

### Polyvinyl Alcohol (PVOH) Composition

The polyvinyl alcohol used for the preparation of the capsules comprised a mixture of 85 wt % of Sekisui Utiloc 2025 polymer and 15 wt % glycerol. This polyvinyl alcohol was rendered less soluble in the laundry liquid detergent formulation by modification as described in WO2006/132729 with 2-acrylamido-2-methyl propane sulphonic acid monomer.

### Stain Monitors

Each monitor comprised a 1 cm diameter Lard stain on CN42 knitted cotton. Lard is known to be highly responsive to lipase.

### Enzyme Capsules

Enzyme capsules comprising polyvinyl alcohol protective film surrounding the enzymes, similar to the capsules used for Example 1 were made. The capsules contained either 0.0233 g Savinase™ 120TXT, or a combination of 0.0233 g Lipex™ 100 TB and 0.0093 g Stainzyme™ 12GT (an amylase). All enzymes were supplied by Novozymes.

Two capsules (one Savinase, one Stainzyme/Lipex) were placed in vials with 2 g of liquid laundry detergent formulation detailed in Table 3.

Control products were also prepared by adding free enzymes (that is, without protective capsules) to the liquid laundry detergent formulation given in Table 3 at the same concentrations. The samples were then stored at 37° C. for two weeks.

At the end of the storage period laundry washes were carried out by separately adding the contents of each vial to one litre of 26° F.H hard water (1:1 polyester:cotton ballast added such that the liquor to cloth ratio was 25:1); washes were performed at 30° C. for 30 minutes and were followed by two rinses in water of the same hardness. Monitors were air dried and cleaning assessed by measuring the Delta E differences using an XRite Colori7 reflectance spectrophotometer.

The results of the washes are provided in Table 4. The larger the Delta DE value (that is the difference between the Delta E after and before washing relative to unstained knitted cotton substrate), the better the cleaning of the formulation.

TABLE 4

| Vial | | Delta DE | +/−(95% |
|---|---|---|---|
| Number | Vial Contents | (Lard) | confidence) |
| 1 | No enzyme present | 32.4 | 2.2 |
| 2 | Savinase/Stainzyme/ | 42.6 | 1.8 |
| | fresh Lipex added at point | | |
| | of use | | |
| 3 | Unaged PVOH capsules | 40.5 | 1.8 |
| | with Savinase in one | | |
| | capsule and Stainzyme/ | | |
| | Lipex in another capsule | | |
| 4 | Aged PVOH capsules with | 39.0 | 1.6 |
| | Savinase in one capsule | | |
| | and Stainzyme/Lipex in | | |
| | another capsule | | |
| 5 | Free | 30.3 | 4.6 |
| | Savinase/Stainzyme/Lipex | | |
| | all aged | | |
| 6 | Free aged Savinase | 32.0 | 1.9 |
| 7 | Free aged Stainzyme | 33.0 | 3.2 |
| 8 | Free aged Lipex | 38.8 | 3.1 |

Aged lipex had been prepared for 14 days and stored at 37° C.

Fresh (unaged) lipex was prepared on the morning of the test.

The differences in cleaning illustrated in Table 4 are related to the amount of active lipase enzyme present. If cleaning is poor it may be concluded that the amount of active lipase present has been reduced. The reduction in lipase activity is known to be due to degradation of the lipase by both denaturation and protease enzyme. It can be seen that there is little difference in the cleaning values obtained for fresh and aged capsules (vials 3, 4) however, the cleaning response for the aged vial with triple enzymes (5) without a capsule achieved the lowest value, presumably because the Savinase (protease) has digested the lipase. It may also be concluded that the capsules dissolved well during the wash and protected the enzymes during storage.

### NMR Analysis of SRP Stability

The survival of the polyester soil release polymer (pSRP) in the same liquid detergent formulations was tracked using NMR analysis.

The NMR data showed:
i) pSRP degradation for the sample with free Lipex. (8)
ii) the free Savinase/Stainzyme/Lipex mixed sample (5) did not degrade the pSRP. This result is not surprising if it is assumed that the Savinase (protease) is degrading the Lipex (lipase) before the Lipex has an opportunity to degrade the pSRP.
iii) The other enzyme combination systems were observed to be stable, with the oligomer peak for the pSRP remaining unchanged and with no evidence of increased peak intensity in the NMR spectra due to an increase in terephthalic acid build-up arising from breakdown of the pSRP. Therefore it may be assumed that the PVOH capsule is effectively shielding the pSRP from the Lipex.
   Wash Cycle Investigation with Dirty Motor Oil (DMO)

A wash cycle investigation with DMO stain on polyester was also carried out to supplement the findings of the NMR analysis data for pSRP protection/degradation with visual observation of the samples washed.

Monitor cloths were prewashed, rinsed and dried twice with an aged test formulation as described above. The cloths were then subsequently stained with one drop of Dirty Motor Oil (DMO) which was allowed to dry. The stained monitors were then washed again with aged test formulations and the results compared visually as illustrated in Table 4b.

TABLE 4b

| Vial | | |
|---|---|---|
| No | Description | Visual Observation |
| 1 | No enzyme present | Virtually clean, almost |
| | | complete removal of stain. |
| 2 | Savinase/Stainzyme/fresh Lipex | Virtually clean, almost |
| | added at point of use | complete removal of stain. |
| 3 | Unaged PVOH capsules with | Virtually clean, almost |
| | Savinase in one capsule and | complete removal of stain. |
| | Stainzyme/Lipex in another capsule | |
| 4 | Aged PVOH capsules with Savinase | Virtually clean, almost |
| | in one capsule and Stainzyme/Lipex | complete removal of stain. |
| | in another capsule | |
| 5 | Free Savinase/Stainzyme/Lipex | Virtually clean, almost |
| | all aged | complete removal of stain. |
| 6 | Free aged Savinase | Virtually clean, almost |
| | | complete removal of stain. |
| 7 | Free aged Stainzyme | Virtually clean, almost |
| | | complete removal of stain. |
| 8 | Free aged Lipex | Very little DMO removal. |

The results clearly demonstrated that samples stored with free Lipex as the sole enzyme present underwent catastrophic pSRP degradation: with virtually no DMO being removed. In contrast, for samples in which the enzymes were protected in polyvinylalcohol capsules, significant removal of DMO indicated that the pSRP was still active.

Indeed, even an aged free Savinase/Lipex/Stainzyme mixture without capsule protection still maintained active pSRP. These finding are in agreement with the NMR data, confirming that on storage without a capsule the Savinase degrades the activity of the Lipex before the Lipex has an opportunity to degrade the pSRP.

### Experiment 3—Encapsulation Studies

A number of Lipex encapsulated particles were prepared by fluid bed coating a modified Lipex T-granule with an anionically modified polyvinyl alcohol (PVOH) (Sekisui Ultiloc 2025). The modified Lipex T-granule comprised additional sodium sulfate on the outer surface to render the surface smoother and the particle more spherical in nature. The sodium sulfate salt was applied by spraying a 25 wt % aqueous solution of the salt onto raw granules over approximately 20 minutes at a temperature of 89 to 93° C. After a 10 minute drying step at 60 to 65° C., PVOH/Mowiol polymer was applied by spraying a 3.1 wt % aqueous polymer solution onto the granules over approximately 150 minutes at 55 to 70° C. The latter step was repeated with intermediate drying steps to produce “2×”, “3×”, “4×” and “5×” granules. Finally, a wax-coat of 5 wt % PEG 4000 was applied by spraying a 9% aqueous solution onto the “5×” granule, thereby producing the “6×” granule. That is, the polymer coatings in 5× and 6× are identical, but only the “6×” granule has a wax coat.

The amount of anionically modified polyvinyl alcohol (PVOH) coating material (that is, the theoretical thickness of the ‘shell’ of the coating) was varied by extracting the Lipex particles from the fluid bed device at different time periods ranging from T=0, that is, ‘0×’, which refers to a particle with no PVOH coating, to T=1, or ‘1×’, which refers to a particle which has one application of PVOH, and so on, to ‘6×’, which refers to a particle which has six coating applications.

In each application, 5 wt % PVOH and 1.2 wt % Mowiol 3-85, both relative to the mass of raw granule, was added as coating. Therefore, the thickness of each coat is in the region of 5 μm, assuming a surface averaged raw granule mean diameter of 600-700 μm.

### Preparation of Liquid Laundry Detergent Formulations Using Lipase Encapsulated Particles

Each of the Lipex encapsulated particles with varying thicknesses of PVOH coating were formulated into three different liquid laundry detergent formulations based on the general formulation described below in Table 5.

TABLE 5

| | | Wt % |
|---|---|---|
| | | (as 100% |
| Ingredient | Function | solids) |
| MPG | Hydrotrope | 15 |
| Neodol 25-7 | Non-ionic surfactant | 10.19 |
| MEA | Neutralisation | 2.36 |
| LAS acid | Alkyl benzene sulfonate | 6.79 |
| | surfactant (anionic non-soap) | |
| TEA | Neutralisation | 2.8 |
| Palmera B1231 | Fatty acid | 1.2 |
| Dequest 2010 | Sequestrant | 2.1 |
| Empigen OB | Surfactant | 1.2 |
| SLES 3EO (EU grade) | Surfactant | 3.39 |
| EPEI (Sokalan HP20) | Cleaning polymer | 4.4 |
| Texcare SRN | Polyester soil release polymer | 3 |
| Proxel GLX | Antimicrobial Preservative | 0.02 |
| Perfume | | 1.19 |
| Additional enzyme or water | | 3.2 |
| Demineralised water | Solvent | Balance |

All three liquid laundry detergent formulations were prepared in the same way and comprised exactly the same level of polyester soil release polymer, PET-POET SRP. However, the type and level of protease enzyme present in the bulk liquid was different for the three formulations.

### Variation in Level and Nature of Protease Enzyme Present in the Bulk Liquid.

1. The first formulation comprised zero protease enzymes.
2. The second formulation comprised a protease enzyme mix containing: 1.4% Relase 16L Ultra (i.e. inhibited protease enzyme), 1.12% L-blend (Stainzyme/Mannaway), 0.48% XPect 1000L and 0.2% Celluclean 5000L.
3. The third formulation comprised a protease enzyme mix containing: uninhibited protease enzyme, 1.4% Relase 16L, 1.12% L-blend (Stainzyme/Mannaway), 0.48% XPect 1000L, 0.2% Celluclean 5000L. XPect1000L is a pectic lyase and Celluclean 5000L is a cellulase enzyme.

Once prepared, all of the samples were placed on store for up to 4 weeks at 37° C. to allow any negative formulation incompatibilities to take place and then to be studied. After the 4 week storage period, each sample was tested for the stability of the polyester soil release polymer (PET-POET SRP).

In addition, after 2 weeks, NMR analysis was also performed for each sample to investigate the stability of the polyester soil release polymer.

Furthermore, after 4 weeks of storage at 37° C., a cleaning assay using dirty motor oil staining on polyester (PE) was performed to establish whether the benefits of the soil release polymer were maintained or lost over the 4 week period at elevated temperature.

### NMR Analysis of Each of the 21 Samples

A summary of the NMR findings is as follows.
1. The NMR analysis for each of the samples with increasing PVOH thickness, (namely 0× to 6×), in the absence of protease enzyme compared with a freshly prepared sample containing polyester soil release polymer, illustrated that the polyester soil release polymer was completely degraded over the complete range of samples. That is, a broad peak on the NMR spectrum for the intact pSRP was completely replaced by a sequence of sharper peaks corresponding to a number of break-down products formed from the pSRP. In other words, in the absence of protease enzymes, there appears to be sufficient lipase leaching from even the most extensively coated 6× encapsulated particles to ensure degradation of the pSRP.
2. NMR analysis was repeated for each sample 0× to 6× for the samples with inhibited protease enzyme. The spectra for these samples revealed that, as the thickness of the PVOH shell increased, the stability of the PET-POET polymer increased. That is, with a PVOH shell thicknesses of only 1 to 2 layers, degradation is apparent. However, as the number of PVOH layers increased to 3 or more, the stability of the PET-POET polymer increases. Therefore it is postulated that as the thickness of the PVOH layer increases, so the rate of escape of lipase enzyme from the lipase encapsulated particles is reduced to a point at which free protease present in the formulation is able to degrade the lipase that leaks out. This effect has two benefits, first of all, the overall residual amount of lipase present in the formulation remains high in anticipation of release during the wash process, and secondly, the benefits of the polyester soil release polymer are maintained.
3. Finally, NMR analysis was repeated again for each of the sample 0× to 6×, with uninhibited protease enzyme. The spectra revealed that there was no polyester soil release polymer degradation with any of the samples, even for the sample with zero PVOH shell. Again, it is postulated that this is due to the fact that the free protease is the liquid formulation is now far more aggressive towards any lipase present in the formulation and rapidly digests the lipase before the lipase has an opportunity to digest the polyester soil release polymer. However, whilst this effect is suitable from the point of view of SRP stability, it is not viable in terms of the presence of any other enzymes present in a liquid detergent formulation as said enzymes will also be rapidly degraded in the presence of uninhibited protease enzyme.

### Measurement of Enzyme Leakage

The level of lipase leakage from the microcapsules after storage at 37° C. for 2 weeks was determined as follows.
i) lipase containing capsule samples were placed in a detergent formulation on store for 2 weeks at 37° C. The samples contained no protease to ensure that any lipase escaping from the capsules was not hydrolysed by protease.
ii) after two weeks the samples were centrifuged, separating the detergent formulation into an upper supernatant liquid and lower capsule layer.
iii) the supernatant liquid was removed and the capsules isolated.
iv) lipase levels in the supernatant liquid was then measured and compared against the lipase level prior to storage at T=O.
v) the amount of lipase leakage was then calculated and expressed as a percentage.

The results showed that for capsules prepared by fluid bed coating, leakage of less than 30% is obtainable. More preferably, leakage of less than 20% is obtainable and preferable for the capsules of the present invention. Most preferably, leakage of less than 15% is achievable and most preferably leakage of less than 10%.

### Cleaning Assays

### Standard Assay for Soil Release Polymer Performance Using DMO Stains on Polyester.

Test cloth swatches were pre-washed, rinsed and dried twice with a selection of the 21 test formulations that had been pre-stored for 4 weeks at 37° C. The pre-prepared swatches were then subsequently stained using dirty motor oil (DMO). One drop of DMO was applied to a polyester swatch with a Pasteur pipette and left overnight to allow full wicking into the fabric. The swatches were then washed (1 Litre of 24 FH water, for 30 minutes, at 30° C.) with the same formulation that had been used for the pre-wash.

The test formulations are the same as those listed in Table 5 with three different combinations of Protease and the 7 different types of Lipase encap (that is, 0× through to 6×). However, not all samples were tested with zero protease because it was very obvious from the NMR that there was no SRP left. Consequently only the sample with the 6× thickest layer was tested to prove this point.

After drying, the swatches were washed in a Tergotometer dried overnight and then measured on an Xrite Colorimeter. The cleaning results are expressed as SRI numbers and are given in Table 6. An SRI of 100 represents complete cleaning of the stain.

TABLE 6

| ‘Thickness’ of | | Relase Ultra | Relase (uninhibited) |
|---|---|---|---|
| PVOH layer | No Protease | Inhibited Protease | Uninhibited Protease |
| Zero ‘0’ | NA | 64.3 | 99.0 |
| 1x | NA | 67.0 | 99.1 |
| 2x | NA | 87.0 | 99.6 |
| 3x | NA | 98.5 | 99.1 |
| 4x | NA | 99.4 | 98.9 |
| 5x | NA | 98.2 | 99.2 |
| 6x | 60.4 | 99.2 | 99.8 |

The cleaning data results support the findings previously presented NMR data. That is, for the samples with six layers of modified polyvinyl alcohol (PVOH) applied to a shell comprising lipase in the absence of protease, it was evident that sufficient lipase enzyme had dissipated though the layers of PVOH to completely breakdown the polyester soil release polymer. A score of around 60 is what would typically be expected for liquid detergent formulations which comprise no polyester soil release polymer.

For the seven samples tested comprising uninhibited protease enzyme in the detergent formulation, the excellent cleaning results demonstrate that the pSRP remained in-tact regardless of the thickness of the modified polyvinyl alcohol (PVOH) applied to a shell comprising the lipase. As indicated previously, this is excellent for pSRP based cleaning but is not acceptable for formulations comprising additional enzymatic cleaning ingredients.

Finally, the results for the seven samples tested comprising inhibited protease enzyme in the detergent formulation, these demonstrate that there is a minimum layer thickness required to achieve stability of the polyester soil release polymer and hence efficient cleaning activity. Without wishing to be bound by any particular theory, it is postulated by the inventors that the thickness of the modified polyvinyl alcohol (PVOH) layer at which stability of the polyester soil release polymer is obtained, is not sufficient to completely prevent release of the lipase enzyme from the encapsulates, (as with free lipase in the absence of protease) but is sufficient to reduce the rate of release of the lipase from the encapsulates to a point at which the inhibited protease in solution effectively controls the amount of free lipase.

### Cleaning Data Demonstrating Lipase Release and Activity

In addition, to the polyester soil release polymers tests described above, a number of tests were also performed to demonstrate that lipase activity remained in the various encapsulates after storage at 37° C. for 4 weeks and that formulations comprising same would still deliver a lipase cleaning benefit.

To this end, a selection of detergent formulations were prepared using a selection of the encapsulated lipases detailed above, either in the absence of protease or with inhibited protease present. The liquid detergent formulations were as described in Table 5 and the levels of inhibited protease were the same as those described in relation to the variation in level and nature of protease enzyme present in the bulk liquid above.

The Lipase options tested were as follows:
i) The liquid detergent formulation of Table 5 in the absence of lipase enzyme as a negative control, for zero lipase cleaning contribution.
ii) a liquid detergent formulation of Table 5 in the presence of encapsulated lipase enzyme with zero layers of modified polyvinyl alcohol (PVOH) applied to the encapsulate (that is, the 0× materials)
iii) a liquid detergent formulation in the presence of encapsulated lipase enzyme with four layers of modified polyvinyl alcohol (PVOH) applied to the encapsulate (that is, the 4× material)
iv) a liquid detergent formulation in the presence of encapsulated lipase enzyme with six layers of modified polyvinyl alcohol (PVOH) applied to the encapsulate (that is, the 6× material)
v) a liquid detergent formulation in the presence of fresh lipase enzyme added at point of use to provide a positive control to demonstrate maximized lipase cleaning contribution.

In each of the examples above, the compositions were tested in the presence and absence of 1.4% Relase 16L Ultra (inhibited protease), 1.12% L-blend (Stainzyme/Mannaway), 0.48% XPect 1000L and 0.2% Celluclean 5000L, ex Novozymes.

The lipase encapsulate level selected for samples ii), iii) and iv) was 1.4% by weight of the total formulation (regardless of the layer thickness). The level selected for sample v) was 1.4% Lipex 100L.

Swatches of material were tested after application of stain CS61, which comprises a beef fat/dye based stain as described above. That is, test cloth swatches were stained using CS61. One drop of CS61 was applied to a polyester swatch with a Pasteur pipette and left overnight to allow full wicking into the fabric. The swatches were then washed (1 Litre of 24FH water, 30 minutes, 30° C.) and investigated for evidence of stain.

The results of the lipase tests are indicated in Table 8 below in terms of the SRI values.

TABLE 8

| | Relase 16 L | No Relase 16 L |
|---|---|---|
| | Ultra Present | Ultra Present |
| Liquid detergent formulation, no | 57.4 | 57.5 |
| lipase enzyme | | |
| Liquid detergent formulation, plus | 60.3 | 64.6 |
| encapsulated lipase enzyme with | | |
| zero layers of modified PVOH. | | |
| Liquid detergent formulation, plus | 60.9 | 63.2 |
| encapsulated lipase enzyme with 4 | | |
| layers of modified PVOH applied to | | |
| encapsulated lipase. | | |
| Liquid detergent formulation, plus | 61.5 | 63.2 |
| encapsulated lipase enzyme with 6 | | |
| layers of modified PVOH applied to | | |
| encapsulated lipase. | | |
| Liquid detergent formulation, plus | 65 | 65 |
| additional lipase enzyme. | | |

The results above indicate the following:

i) there is some loss of lipase enzyme from the encapsulates even with six layers of modified PVOH present on the encapsulated enzyme. One explanation for this result is that in the absence of protease, any escaped lipase enzyme will still contribute to cleaning as it will not be degraded. Conversely, any lipase enzyme escaping in the ‘with-protease’ samples will be degraded by that protease as previously demonstrated. Given the knowledge that any lipase lost form the encapsulates in the ‘with-protease’ samples is rendered inactive, the fact that one still observes lipase activity for the 4 times and six times layers of modified PVOH encapsulates in these test proves that the remaining encapsulated lipase is being released and still has activity. However, the magnitude of this benefit is reduced compared to the lipase positive control.

Therefore, the inventors have devised a household laundry formulation comprising a polyester soil release polymer, which also optionally but preferably comprises hindered free protease and encapsulated lipase. The encapsulated lipase is preferably coated with a modified PVOH layer, along with other laundry cleaning type ingredients, to achieve a formulation which provides lipase enzyme stability and pSRP stability in the presence of protease wherein the protease is ‘free’ in the formulation.

Furthermore, without wishing to be bound by any particular theory, it is submitted that the modified PVOH coatings developed for the encapsulated lipase slows the rate of release of the lipase from the encapsulates to such a degree that the free protease in the formulation is capable of digesting the lipase prior to digestion of the soil release polymer by the lipase.

1. An aqueous liquid laundry formulation comprising:
i) an ester based laundry ingredient;
ii) an effective cleaning amount of protease enzyme;
iii) an effective cleaning amount of lipase enzyme; and
iv) from 5 to 60 wt % surfactant;
characterised in that at least 70 wt % of the effective cleaning amount of lipase enzyme is encapsulated and separated from the ester based laundry ingredient and the liquid by a coating which is insoluble in the formulation but which dissolves on dilution with the wash; and wherein the laundry formulation comprises at least 20 wt % water.

2. An aqueous liquid laundry formulation according to claim 1 which further comprises a structurant.

3. An aqueous liquid laundry formulation according to claim 1 or 2 wherein the coating comprises polyvinyl alcohol, preferably anionically modified polyvinyl alcohol.

4. An aqueous liquid laundry formulation according to any preceding claim wherein the ester based laundry ingredient comprises a polyester soil release polymer, preferably comprising a poly(propylene terephthalate) midblock and endblocks comprising polyoxyethylene.

5. An aqueous liquid laundry formulation according to any of claims 1 to 4 wherein the effective cleaning amount of protease enzyme is in contact with the liquid and is not encapsulated.

6. An aqueous liquid laundry formulation according to any of claims 1 to 5 wherein the effective cleaning amount of protease enzyme comprises hindered protease enzyme.

7. An aqueous liquid laundry formulation according to any preceding claim wherein at least 80 wt % of the effective cleaning amount of lipase enzyme is encapsulated and separated from the ester based laundry ingredient by the coating, more preferably at least 90 wt % of the effective cleaning amount of lipase enzyme is encapsulated and separated from the ester based laundry ingredient by the coating.

8. An aqueous liquid laundry formulation according to any preceding claim wherein at least 95 wt % of the effective cleaning amount of lipase enzyme is encapsulated and separated from the ester based laundry ingredient by the coating.

9. An aqueous liquid laundry formulation according to any of claims 1 to 8 which further comprises non-protease enzymes.

10. An aqueous liquid laundry formulation according to claim 9 wherein the non-protease enzymes are encapsulated with the effective cleaning amount of lipase enzyme.

11. An aqueous liquid laundry formulation according to any of claims 3 to 10 wherein the anionic modification to the polyvinyl alcohol coating comprises less than 10 mol % 2-acrylamido-2-methylpropanesulphonic acid or sodium salt thereof.

12. An aqueous liquid laundry formulation according to any of claims 1 to 11 which further comprises a sequestrant.

13. An aqueous liquid laundry formulation according to any preceding claim wherein the lipase enzyme coating comprises a thickness of greater than or equal to 5 microns, more preferably the lipase enzyme coating comprises a thickness of greater than or equal to 8 microns, even more preferably the lipase enzyme coating comprises a thickness of greater than or equal to 10 microns.

14. An aqueous liquid laundry formulation according to any of claim 2 to 13 wherein the structurant comprises citrus pulp.
